(19) United States
(12) Patent Application Publication
(10) Pub. No.: US 2020/0263856 A1
(43) Pub. Date: Aug. 20, 2020

(54) SOLAR LAMP

(71) Applicant: Joseph Y. KO, Laguna Niguel, CA (US)

(72) Inventor: Joseph Y. KO, Laguna Niguel, CA (US)

(21) Appl. No.: 16/279,107

(22) Filed: Feb. 19, 2019

(51) Int. Cl. F21V 15/02; F21S 6/00; F21S 8/08; F21S 9/03; F21V 21/08

(52) U.S. Cl. CPC F21V 15/02; F21S 6/002; F21W 2131/10; F21S 9/032; F21V 21/0824; F21S 8/081

(57) ABSTRACT

A solar lamp includes a lamp cup, a lamp cover, a solar panel disposed on the lamp cover, and a light emitting module electrically connected with the solar panel. The lamp cup includes an accommodating space, an opening communicated with the accommodating space and a first combining structure disposed in the opening. The first combining structure is divided into at least one limiting section and at least one open section connected with the limiting section. The lamp cover is selectively assembled on the opening of the lamp cup and includes a cover body and a second combining structure disposed at an edge of the cover body. The lamp cover includes a fixed mode in which the second combining structure is positioned on the limiting section and a disassembled mode in which the second combining structure slides to the open section and is separated from the lamp cup.

### FIELD OF THE INVENTION

The present invention relates to a solar lamp, in particular to a solar lamp with a structure which is disassembled or assembled rapidly.

### BACKGROUND OF THE INVENTION

In response to the concept of green energy, more and more lamps are now provided with a solar panel to store photovoltaic power generated by the solar panel during the day or when the light is sufficient for the work of the lamps. In a solar torch lamp disclosed by the patent CN205938937, the solar torch lamp includes a solar panel and a light emitting component. The light emitting component includes a cell, a circuit board and a lamp housing provided with a positioning pipe on an inner side. A wire conduit connected with the cell and the solar panel is disposed in the positioning pipe. However, the light emitting component of the solar torch lamp is disposed on a lamp base. The solar panel transmits power to the cell positioned on the lamp base through the wire conduit, so that there is a line between the solar panel and the lamp base. As a result, it is required to take care of the assembly of the line during assembly of the solar torch lamp, so the assembly procedure cannot be carried out quickly. In addition, the structure of the existing solar lamp cannot be disassembled rapidly, which leads to cumbersome assembly procedures.

### SUMMARY OF THE INVENTION

The main purpose of the present invention is to solve the problem that the existing solar lamp cannot be disassembled and assembled rapidly.

To achieve the above purpose, the present invention provides a solar lamp, including a lamp cup, a lamp cover, a solar panel and a light emitting module. The lamp cup includes an accommodating space, an opening communicated with the accommodating space and a first combining structure disposed on the opening, wherein the first combining structure is divided into at least one limiting section and at least one open section connected with the limiting section. The lamp cover is selectively assembled on the opening of the lamp cup, and the lamp cover includes a cover body and a second combining structure disposed at an edge of the cover body, wherein the lamp cover includes a fixed mode in which the second combining structure is positioned on the limiting section and a disassembled mode in which the second combining structure slides to the open section and is separated from the lamp cup. The solar panel is disposed at one side of the cover body away from the accommodating space, and the light emitting module is electrically connected with the solar panel. The light emitting module is disposed at one side of the cover body facing the accommodating space, wherein the light emitting module is separated from the lamp cup when the lamp cover is in the disassembled mode.

In an embodiment, the limiting section of the first combining structure is formed by a track, and the second combining structure is formed by a sliding block corresponding to the track.

In an embodiment, the light emitting module comprises a power supply unit connected with the solar panel and a light projecting unit connected with the power supply unit.

In an embodiment, the light projecting unit is composed of a circuit board and a plurality of light emitting diodes disposed on the circuit board, and the lamp cover comprises a supporting column disposed at one side of the cover body facing the accommodating space, and the circuit board is disposed on the supporting column.

In an embodiment, the power supply unit includes a cell disposed in the supporting column.

In an embodiment, the lamp cover comprises a light guide housing disposed corresponding to the light projecting unit.

In an embodiment, the lamp cover comprises a switch connected with the power supply unit; the switch outputs a control signal to the power supply unit according to operation, and the power supply unit allows the light projecting unit to enter one of a plurality of light projecting modes based on the control signal.

In an embodiment, the power supply unit allows the light projecting unit to enter one of a plurality of light projecting modes based on photovoltaic power outputted by the solar panel.

In an embodiment, the lamp cup is formed by assembling two half bodies, and each of the half bodies comprises at least one installing structure combined with the other half body.

In an embodiment, the at least one installing structure is selected from a group consisting of a hook-buckle structure, a threading structure and a concave and convex clamping structure.

In an embodiment, the solar lamp includes a supporting element connected with the lamp cup.

### BRIEF DESCRIPTION OF THE DRAWINGS

FIG. 1 is a structural schematic diagram of an embodiment of a solar lamp in the present invention;

FIG. 2 is a three-dimensional exploded view of an embodiment of a solar lamp in the present invention;

FIG. 3 is an exploded view of a partial structure of an embodiment of a solar lamp in the present invention;

FIG. 4 is a first schematic diagram of a disassembled lamp cover of an embodiment of a solar lamp in the present invention;

FIG. 5 is a second schematic diagram of a disassembled lamp cover of an embodiment of a solar lamp in the present invention;

FIG. 6 is a unit composition diagram of an embodiment of a solar lamp in the present invention; and

FIG. 7 is a structural schematic diagram of another embodiment of a solar lamp in the present invention.

### DETAILED DESCRIPTION OF THE PREFERRED EMBODIMENTS

The details and technical contents of the present invention will be described below with reference to drawings.

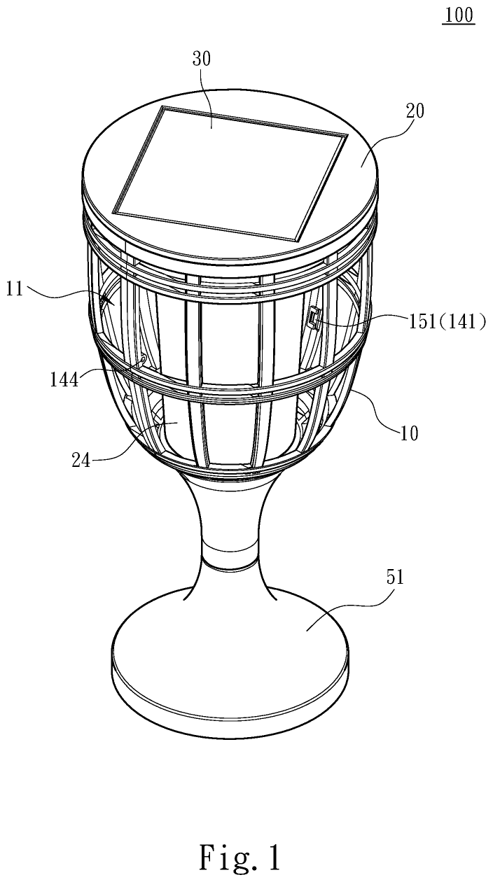

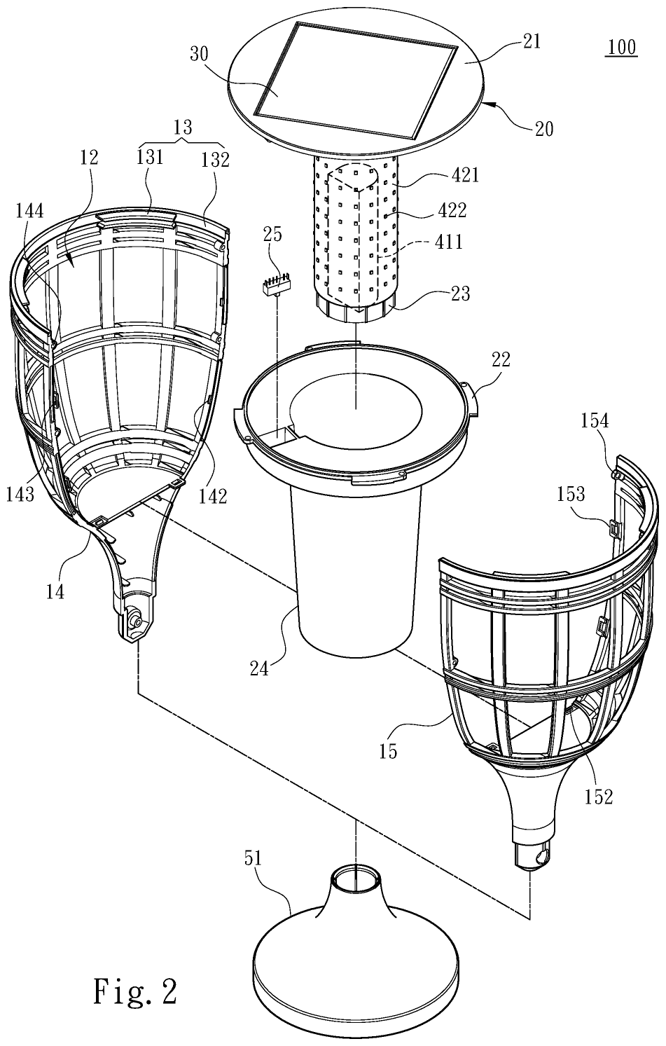

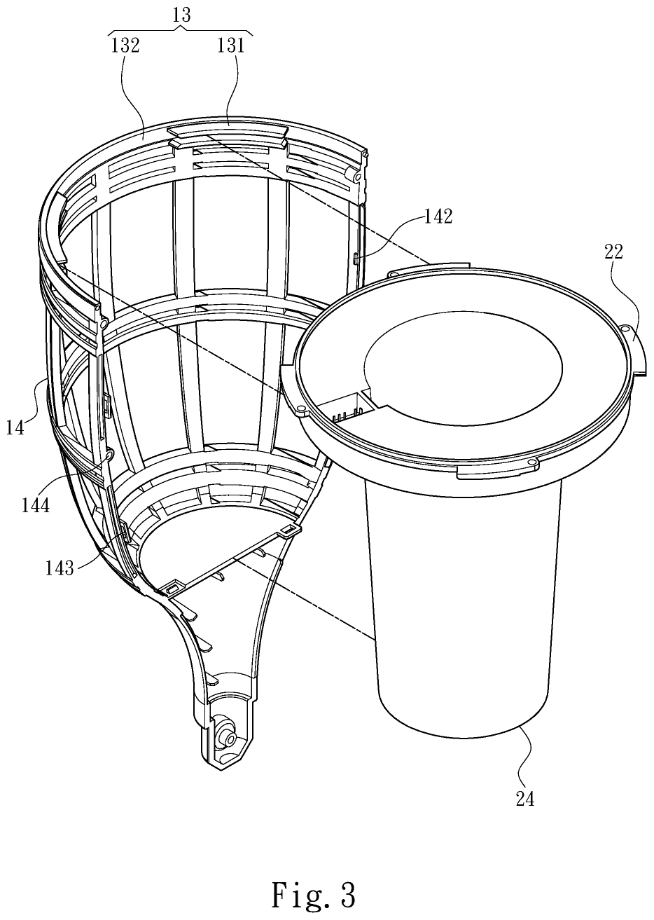

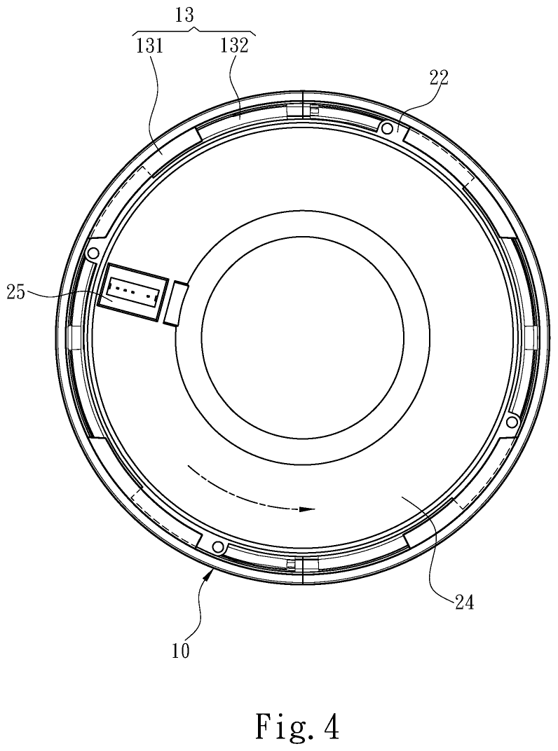

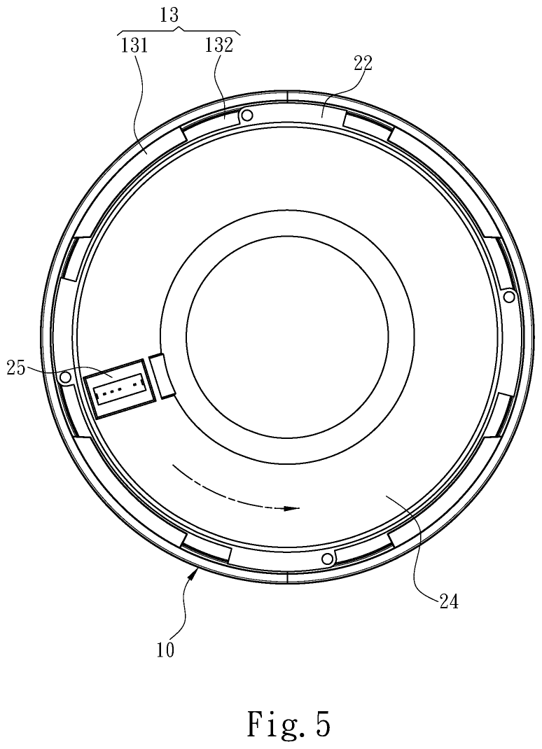

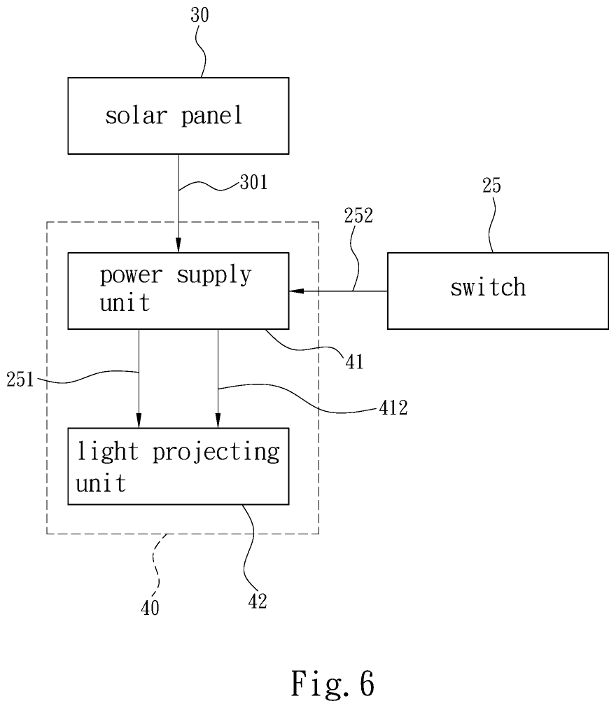

Referring to FIG. 1, FIG. 2, FIG. 3, FIG. 4, FIG. 5 and FIG. 6, the present invention provides a solar lamp 100. The solar lamp 100 includes a lamp cup 10, a lamp cover 20, a solar panel 30 and a light emitting module 40. Specifically, the lamp cup 10 is provided with an accommodating space 11, an opening 12 communicated with the accommodating space 11, and a first combining structure 13 disposed in the opening 12. The first combining structure 13 is divided into at least one limiting section 131 and at least one open section 132 connected with the limiting section 131. Further, the limiting section 131 of the first combining structure 13 is formed by a track. The track is partially disposed on the opening 12 but is not disposed around the whole opening 12. In another word, the portion of the opening 12 which is provided with the track forms the limiting section 131, and the portion of the opening 12 which is not provided with the track forms the open section 132.

Moreover, the lamp cover 20 includes a cover body 21 and a second combining structure 22 disposed at the edge of the cover body 21. Further, the second combining structure 22 is formed by at least one sliding block corresponding to the track, that is, the sliding block is able to slide in the track. The sliding block is partially disposed on the lamp cover 20 but not disposed around the whole edge of the lamp cover 20. Moreover, the lamp cover 20 is selectively assembled on the opening 12 of the lamp cup 10. The lamp cover 20 includes a fixed mode in which the second combining structure 22 is positioned on the limiting section 131 and a disassembled mode in which the second combining structure 22 slides to the open section 132 and is separated from the lamp cup 10. Specifically, the fixed mode or the disassembled mode of the lamp cover 20 is selectively changed through the rotation, and the detailed operation method will be explained below. In one embodiment, the first combining structure 13 is implemented by a plurality of bumps which protrude towards the accommodating space 11, while the second combining structure 22 is implemented by at least one guide groove formed on the lamp cover 20 and configured for the plurality of bumps to move therein.

Moreover, the solar panel 30 is disposed on one side of the cover body 21 away from the accommodating space 11. The light emitting module 40 is electrically connected with the solar panel 30, and is disposed at one side of the cover body 21 facing the accommodating space 11. Further, since the light emitting module 40 of the present invention is not provided with an electrical wire connected with the lamp cup 10, the light emitting module 40 is separated from the lamp cup 10 when the lamp cover 20 is in the disassembled mode.

As described above, in the assembly process, one side of the lamp cover 20 provided with the light emitting module 40 faces the lamp cup 10 and is placed in the accommodating space 11. Subsequently, the second combining structure 22 corresponds to the open section 132 of the first combining structure 13. When the second combining structure 22 and the first combining structure 13 are in the same plane, the lamp cover 20 is rotated and the second combining structure 22 is slid into the limiting section 131 until the lamp cover 20 is limited by the limiting section 131 and unable to be separated from the lamp cup 10; that is, the lamp cover 20 enters the fixed mode. Accordingly, the disassembly of the lamp cover 20 and the lamp cup 10 is performed by the reverse operation of the previous steps, thus the detail description is not be repeated herein. Therefore, the present invention is able to be rapid disassembled and assembled, so that the users can rapidly disassemble the light emitting module 40 from the solar lamp 100 to perform maintenance or replacement work.

Referring to FIG. 1, FIG. 2 and FIG. 6, in one embodiment, the light emitting module 40 comprises a power supply unit 41 connected with the solar panel 30 and a light projecting unit 42 connected with the power supply unit 41. The power supply unit 41 not only includes a power conversion circuit and a control circuit, but also includes a cell 411 disposed in a supporting column 23, wherein the cell 411 is configured to provide a working power 412. In another aspect, the light projecting unit 42 is composed of a circuit board 421 and a plurality of light emitting diodes 422 disposed on the circuit board 421. The light projecting unit 42 receives a working signal 251 sent by the power supply unit 41 to enter one of a plurality of light projecting modes. The plurality of light projecting modes include a standby mode in which the light projecting unit 42 is not actuated, a torch light projecting mode in which the light projecting unit 42 emits flickering light and creates a torch effect, and a constant bright projecting mode in which the light projecting unit 42 emits a steady light. Moreover, the lamp cover 20 comprises the supporting column 23 disposed at one side of the cover body 21 facing the accommodating space 11, wherein the circuit board 421 is disposed on the supporting column 23. The lamp cover 20 further comprises a light guide housing 24 disposed corresponding to the light projecting unit 42.

Moreover, the solar panel 30 of the present invention outputs photovoltaic power 301 to the power supply unit 41 when receiving a light source, while the power supply unit 41 converts the photovoltaic power 301 and store the photovoltaic power 301 into the cell 411 or directly output the photovoltaic power 301 to the light projecting unit 42. In one embodiment, the power supply unit judges the current situation according to the received photovoltaic power 301 and drives the light projecting unit 42 to enter one of the plurality of light projecting modes. That is, the power supply unit 41 controls the solar lamp 100 to enter one of the plurality of light projecting modes based on a power reference. For example, when the photovoltaic power 301 is greater than the power reference, it is judged that the light source is sufficient currently, and the light projecting unit 42 enters the standby mode; and when the photovoltaic power 301 is less than the power reference, it is judged that the light source is insufficient currently, and the light projecting unit 42 enters one of the plurality of light projecting modes. Further, an operator sets one of the plurality of light projecting modes into which the solar lamp 100 enters when the light source is insufficient according to needs, i.e., when the light source is insufficient, the solar lamp 100 enters the standby mode, the constant bright projecting mode or the torch light projecting mode according to the setting. In one embodiment, the lamp cover 20 comprises a switch 25 connected with the power supply unit 41. The switch 25 outputs a control signal 252 corresponding to the operation to the power supply unit 41 according to the operation, then the power supply unit 41 generates the working signal 251 according to the control signal 252 to allow the light projecting unit 42 entering one of a plurality of light projecting modes. Further, the switch 25 is selected from a toggle switch or a push switch. In the case of the toggle switch, different control signals are sent according to different switch positions; and in case of the push switch, different control signals are sent according to push times.

Referring to FIG. 1, FIG. 2 and FIG. 3, in one embodiment, the lamp cup 10 is formed by assembling two half bodies 14 and 15. Each of the half bodies 14 (or 15) comprises at least one installing structure 141 (or 151) to be spliced with the other half body 15 (or 14). The at least one installing structure 141 (or 151) is selected from a group consisting of a hook-buckle structure, a threading structure and a concave and convex clamping structure. Specifically, the at least one installing structure 141 (or 151) is positioned on both sides of each of the half bodies 14 (or 15), and the installing structures 141 and 151 on the two half bodies 14 and 15 are corresponding structures. For example, when the installing structure 141 (or 151) is the hook-buckle structure, the installing structure 141 is a hook 142 and the installing structure 151 is a buckle 153. If the installing structure 141 is a buckle 143, the installing structure 151 is a hook 152. When the installing structure 141 (or 151) is the threading structure, the two installing structures 141 and 151 are respectively installing holes 144 and 154 which provide slicing of locking elements. When the installing structure 141 (or 151) is the concave and convex clamping structure, the installing structure 141 is a protrusion and the installing structure 151 is a groove.

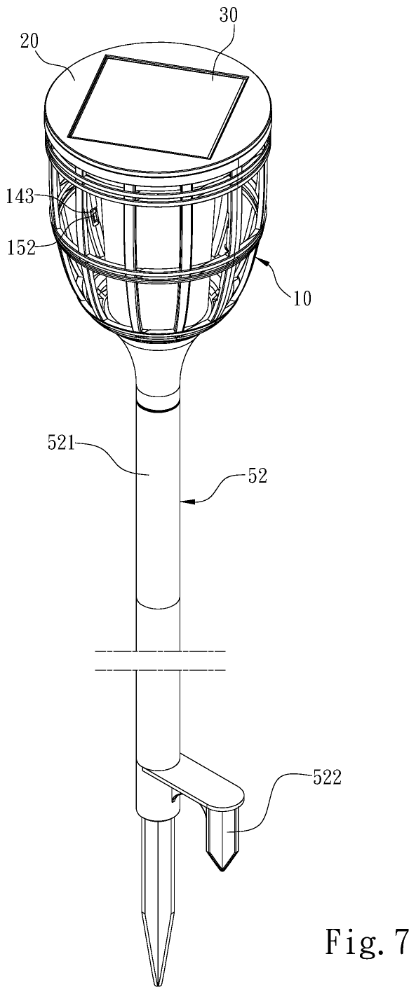

In an embodiment, the solar lamp 100 includes a supporting element which is selectively connected with the lamp cup 10. The supporting element is an installing base 51 or a lamp rod component 52. Specifically, when a user wants to place the solar lamp 100 on a table for illumination, the installing base 51 is selected as the supporting element. In another aspect, when the user wants to place the solar lamp 100 on a garden or courtyard, the lamp rod component 52 is selected as the supporting element, as shown in FIG. 7. Furthermore, in one embodiment, the lamp rod component 52 includes at least one extending section 521, and an inserting section 522 disposed at one end of the lamp rod component 52 away from the solar component and inserted into the soil. Further, the lamp rod component 52 forms the at least one extending section 521 by a plurality of rods.

1. A rapid assembled and disassembled solar lamp, comprising:
a lamp cup including an accommodating space, an opening communicated with the accommodating space and a first combining structure disposed on the opening, wherein the first combining structure is divided into at least one limiting section and at least one open section connected with the at least one limiting section;
a lamp cover selectively assembled on the opening of the lamp cup, comprising a cover body and a second combining structure disposed at an edge of the cover body, wherein the lamp cover includes a fixed mode in which the second combining structure is positioned on the limiting section and a disassembled mode in which the second combining structure slides to the open section and is separated from the lamp cup;
a solar panel disposed at one side of the cover body away from the accommodating space; and
a light emitting module electrically connected with the solar panel and disposed at one side of the cover body facing the accommodating space, wherein the light emitting module is separated from the lamp cup when the lamp cover is in the disassembled mode.

2. The rapid assembled and disassembled solar lamp of claim 1, wherein the limiting section of the first combining structure is formed by a track, and the second combining structure is formed by a sliding block corresponding to the track.

3. The rapid assembled and disassembled solar lamp of claim 1, wherein the light emitting module comprises a power supply unit connected with the solar panel and a light projecting unit connected with the power supply unit.

4. The rapid assembled and disassembled solar lamp of claim 3, wherein the light projecting unit is composed of a circuit board and a plurality of light emitting diodes disposed on the circuit board, and the lamp cover comprises a supporting column disposed at one side of the cover body facing the accommodating space, and the circuit board is disposed on the supporting column.

5. The rapid assembled and disassembled solar lamp of claim 4, wherein the power supply unit comprises a cell disposed in the supporting column.

6. The rapid assembled and disassembled solar lamp of claim 3, wherein the lamp cover comprises a light guide housing disposed corresponding to the light projecting unit.

7. The rapid assembled and disassembled solar lamp of claim 3, wherein the lamp cover comprises a switch connected with the power supply unit, the switch outputs a control signal to the power supply unit according to operation, and the power supply unit allows the light projecting unit to enter one of a plurality of light projecting modes based on the control signal.

8. The rapid assembled and disassembled solar lamp of claim 3, wherein the power supply unit allows the light projecting unit to enter one of a plurality of light projecting modes based on photovoltaic power outputted by the solar panel.

9. The rapid assembled and disassembled solar lamp of claim 1, wherein the lamp cup is formed by assembling two half bodies, and each of the half bodies comprises at least one installing structure combined with the other half body.

10. The rapid assembled and disassembled solar lamp of claim 9, wherein the at least one installing structure is selected from a group consisting of a hook-buckle structure, a threading structure and a concave and convex clamping structure.

11. The rapid assembled and disassembled solar lamp of claim 1, wherein the solar lamp comprises a supporting element connected with the lamp cup.
